(19) United States
(12) Patent Application Publication
(10) Pub. No.: US 2022/0337104 A1
(43) Pub. Date: Oct. 20, 2022

(54) STATOR

(71) Applicant: ebm-papst Mulfingen GmbH & Co. KG, Mulfingen (DE)

(72) Inventors: Michael STURM, Bad Mergentheim (DE); Werner MÜLLER, Mulfingen (DE)

(21) Appl. No.: 17/720,877

(22) Filed: Apr. 14, 2022

(30) Foreign Application Priority Data
Apr. 16, 2021 (DE) 10 2021 109 653.7

(51) Int. Cl. H02K 1/18

(52) U.S. Cl. CPC H02K 1/187

(57) ABSTRACT

Stator of an electric machine, wherein the stator comprises a stator yoke, wherein stator teeth for receiving electrical windings are disposed on the stator yoke, wherein one tooth shoe is disposed on the radial end of each of the stator teeth, wherein the tooth shoe is configured as a separately manufactured component, wherein the tooth shoe 4 upon attaching the electric winding to the stator tooth is able to be plugged in a force-fitting and/or form-fitting manner onto the stator tooth, wherein the connection between the tooth shoe and the stator tooth is configured by means of dovetail joint.

### CROSS-REFERENCE TO RELATED APPLICATION

This application claims the benefit of German Application No. 10 2021 109 653.7, filed Apr. 16, 2021, the contents of which is hereby incorporated by reference in its entirety, further the entirety of the attached translation of German Application No. 10 2021 109 653.7 is incorporated by reference.

### FIELD OF THE DISCLOSURE

The present disclosure relates to a stator of an electric machine.

### BRIEF SUMMARY

A stator of an electric machine, wherein the stator includes a stator yoke, wherein stator teeth for receiving electric windings are disposed on the stator yoke, wherein one tooth shoe is disposed on the radial end of each of the stator teeth, wherein at least one tooth shoe is configured as a separately manufactured component, wherein the tooth shoe upon attaching the electric winding to the stator tooth is able to be plugged in a force-fitting and/or form-fitting manner onto the stator tooth, and wherein the connection between the tooth shoe and the stator tooth is configured by a dovetail joint.

### BRIEF DESCRIPTION OF THE DRAWINGS

FIG. 1 shows a schematic exploded illustration of a stator;

FIG. 2 shows a close-up view of a dovetail joint having a bolt of an external rotor stator;

FIG. 3 shows a close-up view of a dovetail joint having a flat key of an external rotor stator; and

FIG. 4 shows a close-up view of a dovetail joint having a bolt of an internal rotor stator.

### DETAILED DESCRIPTION

Stators of this type are known, for example, from document WO 2011/026795 A1 which discloses a stator of an electric machine, for example of a motor, in particular for the motorized adjustment of movable parts, having a stator yoke, wherein stator teeth for receiving electric windings are disposed on the stator yoke. Tooth shoes are disposed on the radial ends of the stator teeth, wherein each individual tooth shoe is configured as a separately manufactured component which upon attaching an electric winding to a tooth neck of the of stator tooth is able to be fastened to the latter. It is furthermore disclosed that the tooth shoes are able to be plugged in a force-fitting and/or form-fitting manner onto the stator teeth.

Document DE 10 2012 022 868 A1 discloses a comparable stator, in particular of a permanent-magnet excited synchronous machine of an electromechanical steering system, wherein the stator comprises a stator yoke, at least one stator tooth and at least one closure element. The at least one closure element is connected to the stator tooth at a head side of the stator tooth, and/or the at least one stator tooth is connected to the stator yoke at a root side of the stator tooth. Stators of this type have the substantial disadvantage of a poor damping behaviour in relation to vibrations as well as a high generation of noise associated therewith during the operation of the machine. When manufacturing the tooth shoes and the basic stator, the latter comprising the stator yoke and stator tooth, for example from dynamo sheets by punch bundling methods, there is moreover the disadvantage that potential tolerances lead to a restriction in terms of the axial stator length, because the tooth shoe is fitted across the full axial length of the basic stator in the necessary fitting process.

It is, therefore, an object of the present disclosure to refine a stator of the generic type described at the outset, said stator being more resilient in relation to mechanical vibrations, and in particular having a high mechanical strength between the stator tooth and the tooth shoe while at the same time being less restrictive in terms of the design of the axial length of the stator.

This object is achieved according to the present disclosure.

In the context of the present disclosure, the term stator is understood to be an internal rotor stator as well as an external rotor stator.

In the context of the present disclosure, a basic stator comprises a stator yoke and stator teeth, wherein the basic stator and/or the stator tooth can each be produced from dynamo sheets by means of punch bundling methods and/or other additive methods.

The present disclosure describes a stator of an electric machine, for example of a motor, wherein the stator comprises a stator yoke, wherein stator teeth for receiving electric windings are disposed on the stator yoke, wherein one tooth shoe is disposed on a radial end of each of the stator teeth, wherein at least one tooth shoe is configured as a separately manufactured component, wherein the tooth shoe upon attaching the electric winding to the stator tooth is able to be plugged in a force-fitting and/or form-fitting manner onto the stator tooth, wherein the connection between the tooth shoe and the stator tooth is configured by means of a dovetail joint.

High forces, for example by virtue of the permanent magnetic influences and inertias, or by virtue of the vibrations generated by the rotor, can act on the stator during the operation of the electric machine. The present disclosure here can advantageously improve the distribution of forces on the stator and enable that the generation of noise during operation can be reduced and the stability of the stator improved. This is enabled by the dovetail joint in such a way that the latter, by virtue of the taper of said dovetail joint, is implemented as a connection that is self-centring and self-tensioning in the direction of the form-fit.

The stator teeth initially are freely accessible and as a result thereof can be wound swiftly and with a high filling level of the stator groove, or prefabricated winding members, formed from a wire winding, for example, or cast or moulded windings, can be pushed thereon with a high filling level of the groove, before the tooth shoe is subsequently fitted to the basic stator. Advantageously, this also enables a flexible design embodiment of arbitrary constriction of a groove opening of the stator, because said groove opening is independent of the winding technique used.

It is furthermore advantageous, by means of such a modular construction, that an increase in terms of the groove filling factor and the flexibility is enabled by virtue of the construction kit principle thus provided. A significant increase in terms of the efficiency and the torque density can be achieved as a result. An increase in the quantity of copper and thus an increase in terms of the efficiency of the stator can be generated as a result. A possibility for using externally wound coil members or externally moulded coils, for example of copper or aluminium, is thus enabled. Penalties, for example in terms of the mechanical robustness as an external rotor motor, can be reduced. Additional improvements in terms of the vibration and noise behaviour can be made possible by virtue of the design possibilities of the separate tooth shoes.

It is furthermore provided that the tongue of the dovetail joint in the radial direction to the stator is configured so as to be split in two.

As a result, an elasticity of the connection between the stator tooth and the tooth shoe in the tangential direction as well as the in the radial direction of the stator can be generated, this elasticity potentially having an advantageous effect on damping potential oscillations and vibrations of the stator. The compensation of tolerances in the manufacturing of the basic stator and the tooth shoe, for example from dynamo sheets, can also be made possible as a result, this possibly having an advantageous effect on any potential restriction of the length in the production of the stator.

It is furthermore provided that the two parts of the tongue are mutually spaced apart so as to configure a slot.

It is advantageous here that the elastic properties of the dovetail joint can be flexibly adapted by the choice of the width of the slot in relation to the width of the tongue.

It is furthermore provided that the slot is configured for receiving an expansion means, in particular a bolt, preferably a flat key, wherein the expansion means by means of the tongue generates a force-fit between the tooth shoe and the stator tooth.

As a result, a force-fit between the tooth shoe and the stator tooth can be generated and be adapted to the situation by a suitable choice of the expansion means. This can have an advantageous effect in terms of improving the stability of the stator.

It is furthermore provided that the expansion means is configured so as to fill the shape in terms of the slot.

Potential cavities can advantageously be closed so as to avoid degrees of freedoms for vibrations as a result, this in turn being able to be utilized for improving the noise generation and the stability of the stator during operation.

Further details of the present disclosure will be described in the drawings by means of schematically illustrated exemplary embodiments.

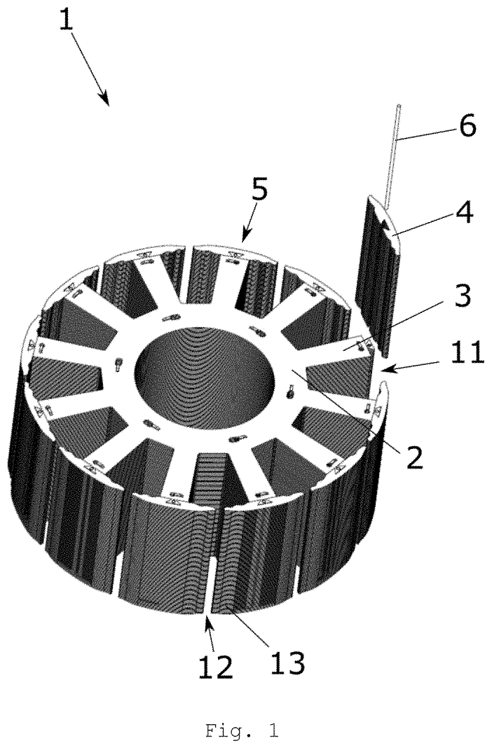

FIG. 1 shows a schematic exploded illustration of a stator 1 according to the present disclosure of an electric machine (not illustrated), having a tooth shoe 4 and expansion means 6. The stator 1 comprises a stator yoke 2, wherein stator teeth 3 for receiving electric windings (not illustrated), which are wound within the stator groove 11 or are inserted as a completely wound functional group, are disposed on the stator yoke 2. One tooth shoe 4 is disposed on the radial end of each of the stator teeth 3, wherein the tooth shoe 4 is configured as a separately manufactured component.

The respective tooth shoe 4 upon attaching the electric winding to the stator tooth 3 is able to be plugged in a force-fitting and/or form-fitting manner onto the stator tooth 3. Winding of the stator tooth 3 prior to attaching the tooth shoe 4 is thus enabled in a freely accessible manner, this being able to be carried out rapidly and swiftly as a result. The plug-fitting of a completely wound functional group with very little remaining installation space is also made possible because the entire groove width of the stator groove 11 is available for the disposal. In that free shaping of the tooth shoe 4 is made possible, the latter as illustrated can be manufactured in such a manner that an ideally constricted groove opening 12 results. This can have a positive effect on the generation of vibrations and noise during the operation of the stator 1, and likewise on the magnetic interaction during the operation of the stator 1 in a motor.

It is furthermore illustrated that the connection between the tooth shoe 4 and the stator tooth 3 is configured by means of a dovetail joint 5. This connection can optimize a distribution of the forces acting on the stator 1 during operation. The self-centring and self-tensioning of said connection, by virtue of the taper of the latter in the direction of the form-fit, can contribute towards an improved vibration and noise behaviour of the stator 1 while at the same time providing a high degree of mechanical stability.

The basic stator (not provided with a reference sign), comprising the stator yoke 2 having the stator teeth 3, like the tooth shoe 4 is manufactured from individual dynamo sheets 13, wherein the dynamo sheets 13 are connected so as to form in each case one basic stator (not provided with a reference sign) and one stator tooth 3, for example by means of a punch bundling method. It is not illustrated in FIG. 1 that additive manufacturing methods are advantageously expedient, in particular in the case of the tooth shoe 4, because the latter can be very delicate, depending on the size of the stator. The production of complex geometries can thus be made possible, and the flexibility can be improved, because expensive punching tools can be dispensed with and the geometry can be flexibly optimized and/or adapted in the course of the product life cycle.

FIG. 2 shows a close-up view of a dovetail joint 5 according to the present disclosure, between the tooth shoe 4 and the stator tooth 3 in a variant of embodiment having a bolt 7. The tongue 8 of the dovetail joint 5 in the radial direction of the stator 1 (illustrated in FIG. 1) is configured so as to be split in two in such a manner that the two parts of the tongue 8 are mutually spaced apart so as to configure a slot 9. The slot 9 is configured for receiving a bolt 7, wherein the bolt 7 by means of the tongue 8 generates a force-fit between the tooth shoe 4 and the stator tooth 3. Tolerances of the tooth shoe 4 and of the stator tooth 3 can be compensated for in the manufacturing process by means of the split-in-two tongue 8 and the slot 9, the latter being adapted to the requirements, in that an elasticity of the dovetail joint is achieved as a result. Great stator construction lengths in the axial direction of the stator can be made possible as a result. An expansion means 6 (illustrated in FIG. 1), such as a bolt 7 illustrated here, which is incorporated thereupon can then ensure a force-fit required for generating a stable connection.

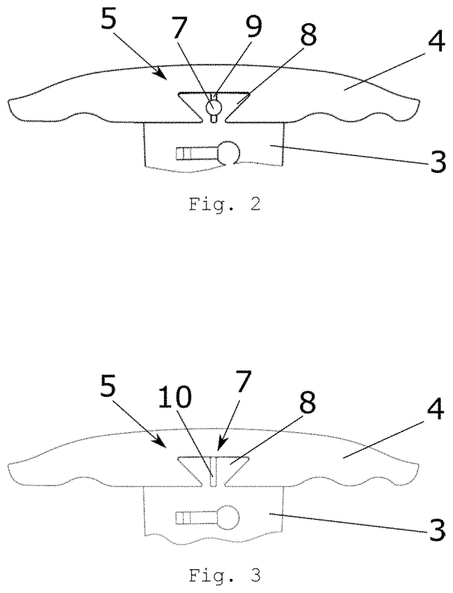

FIG. 3 shows a close-up view of a dovetail joint 5, between the tooth shoe 4 and the stator tooth 3 in a variant of embodiment having a flat key 10. The tongue 8 of the dovetail joint 5 in the radial direction to the stator 1 (not illustrated) is configured so as to be split in two in such a manner that the two parts of the tongue 8 are mutually spaced apart so as to configure a slot 9 (not visible). The slot 9 (not visible) is configured for receiving a flat key 10, wherein the flat key 10 by means of the tongue 8 generates a force-fit between the tooth shoe 4 and the stator tooth 3. It is furthermore illustrated that the flat key 10 is configured so as to fill the shape in terms of the slot 9 (not visible). Cavities can be closed as a result, this potentially having an advantageous effect on the stability as well as the vibration and noise behaviour of the stator during operation.

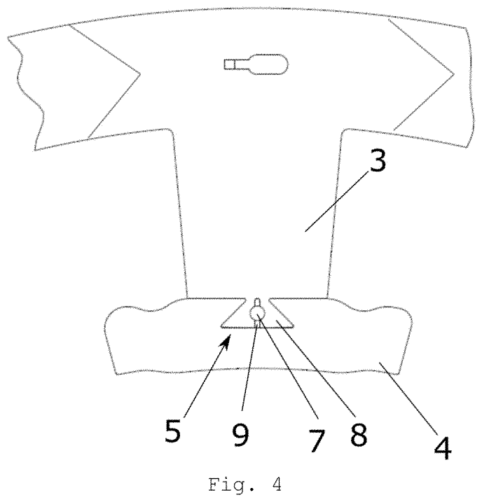

FIG. 4 shows a close-up view of a dovetail joint 5 according to the present disclosure, between the tooth shoe 4 and the stator tooth 3 in a variant of embodiment having a bolt, in a manner analogous to FIG. 2, in the case of an internal rotor stator. The tongue 8 of the dovetail joint 5 in the radial direction of the stator 1 (illustrated in FIG. 1) is configured so as to be split in two in such a manner that the two parts of the tongue 8 are mutually spaced apart so as to configure a slot 9. The slot 9 is configured for receiving a bolt 7, wherein the bolt 7 by means of the tongue 8 generates a force-fit between the tooth shoe 4 and the stator tooth 3. Tolerances of the tooth shoe 4 and of the stator tooth 3 can be compensated for in the manufacturing process by means of the split-in-two tongue 8 and the slot 9, the latter being adapted to the requirements, in that an elasticity of the dovetail joint is achieved as a result. Great stator construction lengths in the axial direction of the stator can be made possible as a result. An expansion means 6 (illustrated in FIG. 1), such as a bolt 7 illustrated here, which is incorporated thereupon can then ensure a force-fit required for generating a stable connection.

Although the present invention has been described with reference to preferred embodiments, workers skilled in the art will recognize that changes may be made in form and detail without departing from the spirit and scope of the invention.

### LIST OF REFERENCE SIGNS

1 Stator
2 Stator yoke
3 Stator tooth
4 Tooth shoe
5 Dovetail joint
6 Expansion means
7 Bolt
8 Tongue
9 Slot
10 Flat key
11 Stator groove
12 Groove opening
13 Dynamo sheet

What is claimed is:

1. A stator of an electric machine,
wherein the stator comprises a stator yoke,
wherein stator teeth for receiving electric windings are disposed on the stator yoke,
wherein one tooth shoe is disposed on the radial end of each of the stator teeth,
wherein at least one tooth shoe is configured as a separately manufactured component,
wherein the tooth shoe upon attaching the electric winding to the stator tooth is able to be plugged in a force-fitting and/or form-fitting manner onto the stator tooth,
wherein the connection between the tooth shoe and the stator tooth is configured by a dovetail joint.

2. The stator of claim 1, wherein the tongue of the dovetail joint in the radial direction to the stator is configured so as to be split in two.

3. The stator of claim 1, wherein the two parts of the tongue are mutually spaced apart so as to configure a slot.

4. The stator of claim 1, wherein the slot is configured for receiving an expansion means, wherein the expansion means by means of the tongue generates a force-fit between the tooth shoe and the stator tooth.

5. The stator of claim 4, wherein the expansion means comprises a bolt.

6. The stator of claim 5, wherein the bolt comprises a flat key.

7. The stator of claim 1, wherein the expansion means is configured so as to fill the shape in terms of the slot.
